(19) United States
(12) Patent Application Publication
(10) Pub. No.: US 2013/0139599 A1
(43) Pub. Date: Jun. 6, 2013

(54) APPARATUS AND METHOD FOR MEASURING SIGNAL USING SINC FUNCTION

(71) Applicants: Yeol ho LEE, Seoul (KR); Youn Suk CHOI, Yongin-si (KR); Soo Suk LEE, Suwon-si (KR); Woo Chang LEE, Anyang-si (KR)

(72) Inventors: Yeol ho LEE, Seoul (KR); Youn Suk CHOI, Yongin-si (KR); Soo Suk LEE, Suwon-si (KR); Woo Chang LEE, Anyang-si (KR)

(73) Assignee: SAMSUNG ELECTRONICS CO., LTD., Suwon-si (KR)

(21) Appl. No.: 13/570,966

(22) Filed: Aug. 9, 2012

(30) Foreign Application Priority Data
Dec. 5, 2011 (KR) 10-2011-0129002

(51) Int. Cl. G01N 29/44

(52) U.S. Cl. 73/602

(57) ABSTRACT

This disclosure describes an apparatus for sensing a target using a sinc function, a surface acoustic wave (SAW) sensor system including the same, and a method of measuring a target using a sinc function. The apparatus for measuring a target using the sinc function may measure an output signal from a SAW sensor with high precision and reliability.

### CROSS-REFERENCE TO RELATED APPLICATION

This application claims the benefit of Korean Patent Application No. 10-2011-0129002, filed on Dec. 6, 2011, and all the benefits accruing therefrom under 35 U.S.C. §119 which is hereby incorporated by reference as if fully set forth herein.

### BACKGROUND

1. Field

Provided are an apparatus for measuring a signal using a sinc function which has high precision and measurement reliability, a surface acoustic wave (SAW) sensor system including the same, and a method of measuring a signal using a sinc function.

2. Description of the Related Art

A surface acoustic wave (SAW) sensor refers to an element or device for detecting or measuring an absolute value of a physical quantity or a chemical quantity, a change in physical quantity or chemical quantity, or intensity of a sound, light or a radio wave from a target using a base and surface sensing technique and a SAW, and converting them into an electrical signal.

SAW sensors are classified according to types of targets. For example, the SAW sensors may include a biosensor for detecting protein, deoxyribonucleic acid (“DNA”), a virus, a bacterium, a cell, a tissue, and the like, a gas sensor for detecting toxic gas or flammable gas, and the like, a temperature sensor for detecting temperature, a pressure sensor for detecting pressure, and a humidity sensor for detecting humidity. The SAW sensor may be used in various fields.

### SUMMARY

Provided is an apparatus for measuring a target, which has high precision and measurement reliability by sweeping the entire band at once or at the same time using a sinc function.

According to an aspect, disclosed is an apparatus for measuring a target using a surface acoustic wave (“SAW”) sensor using a sinc function comprising an input signal transmitting part for inputting a signal into the SAW sensor by the sinc function, and an output signal receiving part from the SAW sensor.

The input signal transmitting part may include a sinc function generator, and a digital-to-analog converter (“DAC”). The input signal transmitting part may further include a modulator, a filter, and optionally an amplifier.

The output signal receiving part may include an analog-to-digital converter (“ADC”) and a signal analyzer. The output signal receiving part may further include a filter, a demodulator, and optionally an amplifier.

According to another aspect, disclosed is a SAW sensor system comprising an input signal transmitting part for inputting a signal into an SAW sensor using a sinc function, an SAW sensor, and an output signal receiving part from the SAW sensor.

The SAW sensor may include a piezoelectric substrate, an inputting part, a sensing part and an outputting part.

According to another aspect, disclosed is a method of sensing a target including generating a first sinc signal, converting the first sinc signal into a first electrical signal with a certain frequency bandwidth, inputting the converted first electrical signal into an SAW sensor, sensing a target from the SAW sensor using a first SAW from the SAW sensor, outputting a second SAW corresponding to the sensed target; converting the second SAW into a second electrical signal, converting the second electrical signal into a second sinc signal, and comparing the first sinc signal with the second sinc signal.

According to the method of measuring a target using a SAW sensor, the precision and measurement reliability may be further improved, compared to that of measuring a signal using a conventional network analyzer.

### BRIEF DESCRIPTION OF THE DRAWINGS

The above and other embodiments, advantages and features of this invention will become more apparent by describing in further detail exemplary embodiments thereof with reference to the accompanying drawings, in which:

FIG. 1 shows a principle of measuring a signal using a network analyzer.

FIG. 2 shows a principle of a sinc function.

FIG. 3 shows a principle of a sinc function.

FIG. 4 shows a schematic diagram of an apparatus for measuring a signal using a sinc function.

FIG. 5 shows an apparatus for measuring a signal using a sinc function according to one exemplary embodiment.

FIG. 6 shows the results of measuring phase precision using the measuring apparatus of FIG. 5.

FIG. 7 shows an enlarged diagram of the graph of FIG. 6.

FIG. 8 shows the results of measuring phase precision using the network analyzer.

FIG. 9 shows an enlarged diagram of the graph of FIG. 8.

### DETAILED DESCRIPTION

The invention now will be described more fully hereinafter with reference to the accompanying drawings, in which a non-limiting embodiment is shown. This invention may, however, be embodied in many different forms, and should not be construed as limited to the example embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated regions, integers, steps, operations, elements, and/or components, but do not preclude the presence or addition of one or more other regions, integers, steps, operations, elements, components, and/or groups thereof.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

One or more embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear portions. Moreover, sharp angles that are illustrated may be rounded. Thus, the regions illustrated in the figures are schematic in nature and their shapes are not intended to illustrate the precise shape of a region and are not intended to limit the scope of the claims.

Hereinafter, embodiments of the invention will be described in further detail with reference to the accompanying drawings.

In general, the transmission characteristics of a surface acoustic wave (SAW) sensor are analyzed by universal measurement equipment such as a network analyzer. The network analyzer is an instrument that measures the network parameters of electrical networks. The network analyzer includes a frequency source and a spectrum analyzer, and may measure scattering parameters (S parameters) by comparing the results of distribution of input and output frequency signals. A principle of measuring the network analyzer is shown in FIG. 1.

Referring to FIG. 1, the network analyzer inputs a sine signal corresponding to each frequency point in a certain frequency band (fᵢ to f_{f}) into a SAW sensor, converts a characteristic signal of a time domain from the SAW sensor into a frequency domain using a Fourier transform, and then observes a change in center frequency (f_{c}) from the converted frequency domain and a phase according to the change in center frequency.

However, the network analyzer may accurately measure a signal of a measurement band while sweeping the signal only when there are no changes in signal transmission characteristics and speed. In the SAW sensor, characteristics of an acoustic medium are changed with time by a biochemical reaction. Since there is a time difference in input/output signals at each frequency point during a sweeping process, a measurement error may be caused. Therefore, provided is an apparatus for measuring a signal having high precision and measurement reliability by sweeping the entire band at once or at the same time using a sinc function.

According to one exemplary embodiment, an apparatus for measuring a target using a SAW sensor is provided. The apparatus may include an input signal transmitting part for inputting a signal into a SAW sensor by a sinc function, and an output signal receiving part from the SAW sensor.

As used herein, the term “sinc function” refers to a function represented by a ratio of a sine function and a variable thereof. The sinc function is defined as follows.

$$sinc ( x ) = \frac{sin ( x )}{x}$$

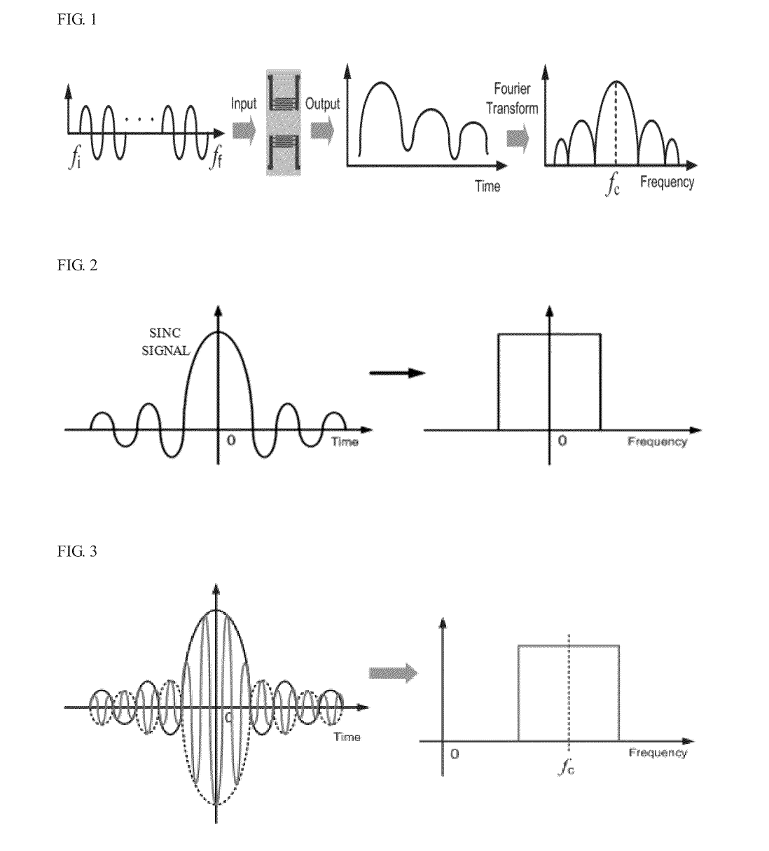

The principles of the sinc function are shown in FIGS. 2 and 3, respectively. Referring to FIGS. 2 and 3, the sinc function may modulate a frequency component to be used at a certain frequency band and measure the same input/output signals even when the characteristics of the acoustic medium are changed over time. Thus, it is possible to input/output each frequency point within the same time zone in which it is unnecessary to sweep the entire band.

As used herein, the term “input signal transmitting part” refers to a device capable of generating an input signal using a sinc function, amplifying or filtering the generated input signal and transferring the amplified or filtered input signal into a SAW sensor. The input signal transmitting part may include a sinc function generator, a DAC, a modulator and an output signal filter.

The term “sinc function generator” refers to a device for generating a sinc signal as a digital signal.

The term “DAC” refers to a device for converting a sinc signal which is a digital signal from the sinc function generator, into an electrical signal which is an analog signal that is able to be applied to a SAW sensor.

The term “modulator” refers to a device for shifting a frequency of the analog signal converted by the DAC into an operating frequency band of the SAW sensor.

The term “output signal filter” refers to a device for removing noise signals beyond a desired frequency band. In order to remove the noise signals, a variety of filters such as a band pass filter or a low-pass filter may be used.

The input signal transmitting part may further include an “output signal amplifier” for amplifying an analog signal whose frequency is shifted by the modulator to an amplitude suitable to apply the analog signal to the SAW sensor.

As used herein, the term “output signal receiving part” refers to a device capable of analyzing a material bound to the SAW sensor by amplifying or filtering a signal passing through the SAW sensor. The output signal receiving part may include an input signal filter, a demodulator, an ADC, and a signal analyzer.

The term “input signal filter” refers to a device for removing noise signals beyond the signals for the signal analyzer. In order to remove the noise signals, a variety of filters such as a band pass filter or a low-pass filter may be used.

The term “demodulator” refers to a device for returning a modulated analog signal into an original signal.

The term “ADC” refers to a device for converting an electrical signal which is an analog signal from the SAW sensor, into a sinc signal that is a digital signal.

The term “signal analyzer” refers to a device for detecting the signal from the SAW sensor, compare the detected signal with an input signal, and sense a material bound to the SAW sensor. The signal analyzer may quantitatively and qualitatively analyze a target material by analyzing changes in frequency, phase and signal intensity of each of the signal output from the SAW sensor and the signal from the sinc function generator.

The output signal receiving part may further include an “input signal amplifier” for amplifying a signal from the SAW sensor to amplitude suitable to detect the signal at the signal analyzer.

According to another exemplary embodiment, a SAW sensor system using a sinc function is disclosed.

As used herein, the term “SAW sensor” refers to a device for sensing presence and absence or a physical property and/or a chemical property of the target using a SAW. The term “SAW” refers to a mechanical wave motion rather than an electromagnetic wave, which is generated from movement of particles due to various causes such as external thermal, mechanical or electrical forces. The SAW typically includes vibration energy concentrated on a surface of an elastic body, it is propagated along the surface of a solid as an earthquake is propagated along the ground. SAWs are classified into shear horizontal SAWs (“SH-SAWs”) and a surface transverse wave (“STW”) according to the direction of propagation, and also classified into flexural plate waves (“FPWs”), Love waves, surface skimming bulk waves or Lamb waves according to a purpose of use, for example, but is not limited thereto. Among these, the Lamb wave is mainly used for sensing a gas, and the Love wave is mainly used for sensing a liquid, for example.

The SAW sensor may convert an electrical signal into a SAW. The SAW sensor may sense the target using the SAW, and then convert a SAW output corresponding to the target into an electrical signal. The SAW sensor may include a piezoelectric substrate, an inputting part, a sensing part, and an outputting part.

The term “piezoelectric substrate” refers to a substrate including a piezoelectric material. The piezoelectric material has an electrical characteristic that is changed when a mechanical signal is applied (i.e., piezoelectric effect). Conversely, a mechanical signal is generated when an electrical signal is applied (i.e., the reverse piezoelectric effect).

The piezoelectric material may include a metallic oxide or an insulating material, but is not limited thereto. For example, the piezoelectric material may include, but is not limited to, a metallic oxide such as lithium niobate (“LiNbO₃”), lithium tantalate (“LiTaO₃”), lithium tetraborate (“Li₂B₄O₇”), barium titanate (“BaTiO₃”), lead zirconate (“PbZrO₃”), lead titanate (“PbTiO₃”), lead zirconium titanate (“PZT”), zinc oxide (“ZnO”), gallium arsenide (“GaAs”), quartz, niobate, berlinite, topaz, tourmaline group materials, potassium niobate, sodium tungstate, Ba₂NaNb₅O₅, and Pb₂KNb₅O₁₅. Also, the piezoelectric material may include a piezoelectric polymer or a copolymer or mixture including at least one piezoelectric polymer, but is not limited thereto. For example, the piezoelectric polymer may be polyvinylidene fluoride, and a copolymer or mixture of polyvinylidene fluoride may also be used. The copolymer may include a block copolymer, an alternating block copolymer, a random copolymer, a random block copolymer, a graft copolymer, a star block copolymer, or any combination thereof. A copolymer that may be copolymerized with polyvinylidene fluoride may include, but is not limited to, polytrifluroethylene, polytetrafluroethylene, polyacrylamide, polyhexafluropropylene, polyacrylic acid, poly-(N-isopropylacrylamide), polyacetal, polyolefin, polyacrylic, polycarbonate, polystyrene, polyester, polyamide, polyamideimide, polyacrylate, polyacrylsulfone, polyethersulfone, polyphenylene sulfide, polyvinyl chloride, polysulfone, polyimide, polyetherimide, polytetrafluroethylene, polyetherketone, polyphthalide, polyacetal, polyanhydrade, polyvinyl ether, polyvinyl thioether, polyvinyl alcohol, polyvinyl ketone, polyvinyl halide, polyvinyl nitrile, polyvinyl ester, polysulfonate, polysulfide, polythioester, polysulfone, polysulfoneamide, polyurea, polyphosphazene, polysilazane, or any combination thereof. The copolymer may include an electrically insulating polymer, and may be rendered electrically conductive by adding an intrinsically conductive polymer or an electrically conductive filler to the respective polymer.

Further, the piezoelectric material may include a composite that contains a polymer blended with other piezoelectric polymers. The piezoelectric polymer may include a filter that displays a piezoelectric characteristic to form a piezoelectric composite. For example, the piezoelectric filler may include, but is not limited to, lithium niobate (“LiNbO₃”), lithium tantalate (“LiTaO₃”), lithium tetraborate (“Li₂B₄O₇”), barium titanate (“BaTiO₃”), lead zirconate (“PbZrO₃”), lead titanate (“PbTiO₃”), lead zirconium titanate (“PZT”), zinc oxide (“ZnO”), gallium arsenide (“GaAs”), quartz, niobate, berlinite, topaz, a tourmaline group material, calcium niobate, sodium tungstate, Ba₂NaNb₅O₅, and Pb₂KNb₅O₁₅ or any combination thereof.

The term “inputting part” refers to an area which is formed on one side of a piezoelectric substrate for converting an electrical signal into a SAW that is a mechanical signal. The inputting part may include an interdigital transducer (“IDT”). The inputting part may be formed by patterning a metallic material on a piezoelectric substrate into a previously set form. The metallic material may include, but is not limited to, a thin-film metal such as an aluminum alloy, a copper alloy or gold. In order to prevent corrosion of the metallic material due to exposure to atmosphere or moisture, a protective layer such as an anti-oxidant layer may be disposed on a surface of the metallic material. For example, the metallic material may include aluminum or an aluminum alloy, and an aluminum oxide thin film formed on a surface thereof. The aluminum alloy may include aluminum (“Al”) as a main component, and also may include at least one selected from the group consisting of titanium (“Ti”), silicon (“Si”), chromium (“Cr”), tungsten (“W”), iron (“Fe”), nickel (“Ni”), cobalt (“Co”), lead (“Pb”), niobium (“Nb”), tantalum (“Ta”), zinc (“Zn”), vanadium (“V”), or any combination thereof. The aluminum oxide thin film may be an artificially or natively formed aluminum oxide.

Further, an insulating layer may be formed on the piezoelectric substrate since the metallic material may operate in a solution. The insulating film may be used to insulate an IDT electrode, and also used as a wave guide layer when a Love wave is generated. The insulating layer and the wave guide layer may include a polymer such as a silicon oxide (“SiO₂”) layer, a silicon nitride (“SiₓN_{y}”) layer, a zinc oxide (“ZnO”) layer, parylene and polymethyl methcrylate (“PMMA”), or any combination thereof. For example, the silicon oxide layer may be used alone, and may be used together with the zinc oxide film by coating the zinc oxide film with the silicon oxide film.

The term “sensing part” refers to an area which is formed on a piezoelectric substrate and capable of outputting a SAW corresponding to a target so as to sense the target when the SAW is input into an inputting part.

The sensing part may include a delay line between the inputting part and the outputting part, and may include a film form or a cell form. When the target is contacted to a surface of the sensing part, a SAW that is different in frequency, phase or energy (or energy loss) amplitudes may be generated, due to influence of various types of causes such as pressure, rotator force, shock, tensile force, gravity, mass, evaporation, biochemistry, temperature, humidity, freezing, viscosity, displacement, liquidity, light sensing, optic angle, acceleration, abrasion, contamination, and the like.

The target may include, but is not limited to, protein, DNA, viruses, bacteria, cell, tissue, gas, temperature, pressure, humidity, and the like.

The term “outputting part” refers to an area which is formed on one side of a piezoelectric substrate and capable of converting a mechanical signal into an electrical signal so as to analyze the SAW which is output and received from the sensing part. In general, the outputting part may be formed at an opposite side to the inputting part with the sensing part interposed therebetween. The outputting part may have a form which is identical to or modified from the inputting part.

The outputting part may be formed by patterning a metallic material on a piezoelectric substrate into a previously set form. The metal material is the same as in the inputting part.

The SAW sensor may be classified according to types of the target. For example, the SAW sensor may include a biosensor for detecting proteins, DNA, a virus, a bacterium, a cell and a tissue, and the like, a gas sensor for detecting toxic gas or flammable gas, a temperature sensor for detecting temperature, a pressure sensor for detecting pressure, and a humidity sensor for detecting humidity, but is not limited thereto.

According to the exemplary embodiment, the SAW sensor system may include an input signal transmitting part for inputting a signal into a SAW sensor by a sinc function, a SAW sensor, and an output signal receiving part from the SAW sensor.

The SAW sensor system may include a sinc function generator, a DAC, a SAW sensor, an ADC and a signal analyzer.

The SAW sensor system may include a sinc function generator, a DAC, a modulator, an output signal filter, a SAW sensor, an input signal filter, a demodulator, an ADC and a signal analyzer.

The SAW sensor system may include a DAC, a modulator, an output signal filter, an output signal amplifier, a SAW sensor, an input signal filter, an input signal amplifier, a demodulator, an ADC and a signal analyzer.

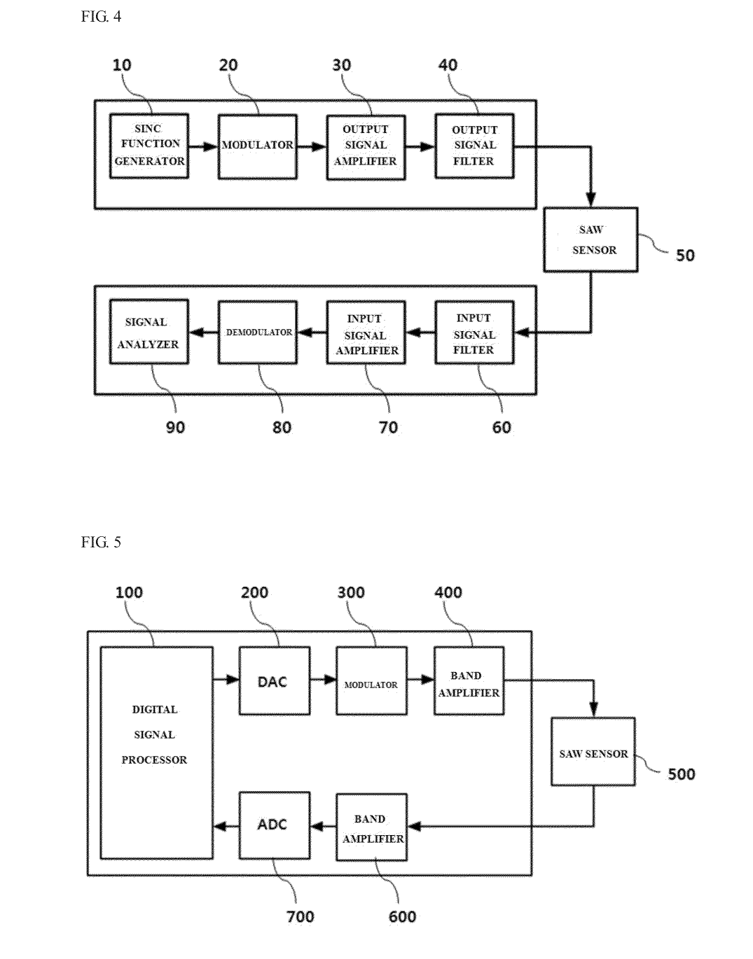

One exemplary embodiment of the apparatus for measuring a target using a SAW sensor is shown in FIG. 4.

Referring to FIG. 4, a digital signal generated by the sinc function generator 10 is converted into an analog signal by the DAC, and a frequency of the converted analog signal is shifted into an operating frequency band of the SAW sensor by the modulator 20. The shifted analog signal is amplified by the output signal amplifier 30, and noise signals are removed by the output signal filter 40, and then input into the SAW sensor 50.

In the inputting part of the SAW sensor 50, an electrical signal is converted into a SAW, and characteristics of the SAW are changed according to the bound target as the SAW passes through the sensing part. The SAW passing through the sensing part is converted to an electrical signal at the outputting part and output from the outputting part.

Noise signals are removed from the output electrical signal by an input signal filter 60 and the output electrical signal is then amplified by an input signal amplifier 70. Thereafter, a modulated analog signal is returned to an original analog signal by a demodulator 80, the original analog signal is converted into a digital signal by the DAC, and the converted digital signal is analyzed by a signal analyzer 90.

According to another exemplary embodiment, a method of sensing a target is disclosed. The method includes a signal using a sinc function including generating a first sinc signal, converting the first sinc signal into a first electrical signal with a certain frequency bandwidth, inputting the converted first electrical signal into an SAW sensor, sensing the target from the SAW sensor using a first SAW from the SAW sensor, outputting a second SAW corresponding to the sensed target; converting the second SAW into a second electrical signal, converting the second electrical signal into a second sinc signal, and comparing the first sinc signal with the second sinc signal.

First, a first sinc signal that is a digital signal generated by the sinc function generator 10 is converted into a first electrical signal, which is an analog signal with a certain frequency bandwidth, by the DAC.

The converted first electric signal is converted into a first SAW which is a mechanical signal as the first electrical signal passes through the inputting part (i.e., the input IDT) of the SAW sensor 50. The first SAW may be changed by a physical, chemical or electric reaction as the sensing part is bound to a target. As one example, a frequency, phase, or energy amplitude of an output signal of the SAW may be changed. The changed second SAW is converted into a second electrical signal that is an analog signal as the second SAW passes through the outputting part, for example, the output IDT.

The converted second electric signal is converted to a second sinc signal that is a digital signal by the DAC, and the physical properties of a target, such as pressure, rotator force, shock, tensile force, gravity, mass, evaporation, biochemistry, temperature, humidity, freezing, viscosity, displacement, liquidity, light sensing, optic angle, acceleration, abrasion, contamination, and the like, may be accurately detected by comparing the frequency, phase and intensity of the first sinc signal and the second sinc signal. Furthermore, it is possible to quantitatively and qualitatively analyze a measurement target.

When a signal of the SAW sensor is measured using the sinc function according to the exemplary embodiments, the precision and measurement reliability may be further improved, compared to those obtained from the use of a conventional network analyzer. For example, when a signal of the SAW sensor is measured using the sinc function, the precision and measurement reliability may be improved at least 5 times.

Hereinafter, the exemplary embodiments and experimental examples of the invention will be described in further detail. However, they are not intended to limit the scope of the invention.

### EXAMPLE 1

An apparatus for measuring a signal using a sinc function was configured, as shown in FIG. 5. The measuring apparatus includes a digital signal processor, a DAC, a modulator, an amplifier and an ADC.

A digital signal processor 100 including the sinc function generator and the signal analyzer is designed with a field-programmable gate array (“FPGA”) and a central processing unit (“CPU”). A product having performances of 16 BIT and 800 MSPS (Trademark: AD9788BSVZ commercially available from Analog Devices, Inc.) is used as the DAC 200 for converting a sinc digital signal in the digital signal processor 100 into an analog signal.

A frequency of the converted analog signal is shifted into an operating frequency band (for example, 400 MHz or 200 MHz) of a SAW sensor using a frequency modulator 300. The sinc signal whose frequency was shifted is output as a signal, from which noise signals beyond the band are removed, using a band amplifier 400 including an amplifier and a filter.

Noise signals beyond a measurement frequency are removed from an electrical signal, which passed through targets (acute myocardial infarction markers: troponin, mioglobin and CK-MB) in the SAW sensor, using a band amplifier 600. The electrical signal that is an analog signal is converted into a sinc digital signal by an ADC 700 using a product having performances of 14 BIT and 150 MSPS (trade name: AD9640BCPZ-105 commercially available from Analog Devices, Inc.).

The converted sinc digital signal is transferred to a digital signal processor, and the transmission characteristics of the SAW sensor are measured by analyzing the transferred sinc digital signal and a sinc digital signal generated for the first time.

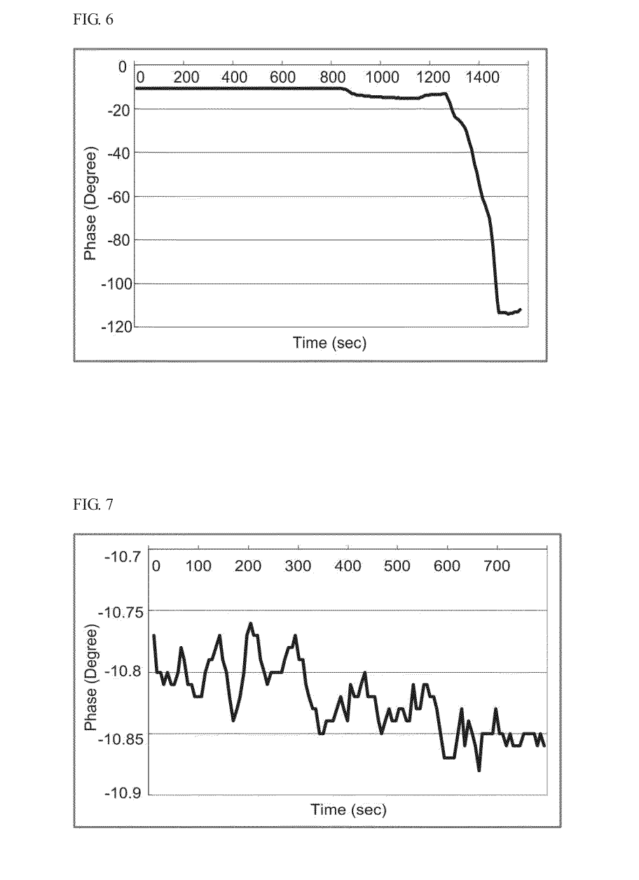

The results are shown in FIGS. 6 and 7.

### COMPARATIVE EXAMPLE 1

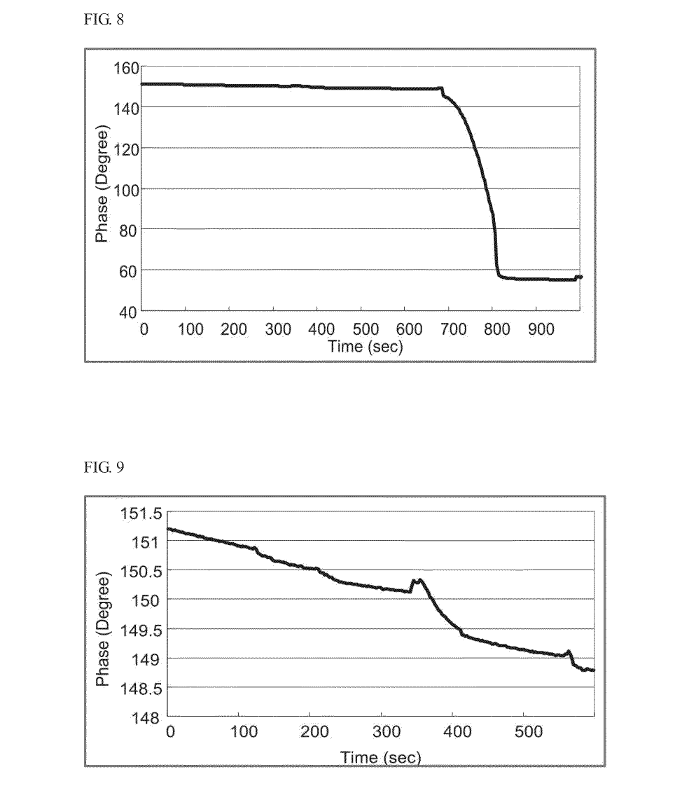

The transmission characteristics of a SAW sensor are measured using a network analyzer. The measured results are shown in FIGS. 8 and 9.

As shown in FIGS. 6 to 9, it is seen that when a signal output from the SAW sensor is analyzed using a network analyzer, a degree of precision of a phase is approximately 3° (FIGS. 6 and 7), and a degree of precision of a phase is approximately 0.2° (FIGS. 8 and 9) when using the apparatus for measuring a signal using a sinc function according to the exemplary embodiments.

From the results of Examples, it is confirmed that it is possible to design a sensor capable of lowering a measurement error of an output signal from the SAW sensor and having high precision and measurement reliability when the apparatus for measuring a signal using a sinc function is used, compared to when using a network analyzer.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An apparatus for measuring a target using a surface acoustic wave (SAW) sensor comprising:
an input signal transmitting part for transmitting an input signal to a SAW sensor, the input signal comprising a sinc function; and
an output signal receiving part for receiving an output signal from the SAW sensor.

2. The apparatus according to claim 1, wherein the input signal transmitting part comprises a sinc function generator and a digital-to-analog converter.

3. The apparatus according to claim 2, wherein the input signal transmitting part further comprises a modulator and a filter.

4. The apparatus according to claim 3, wherein the input signal transmitting part further comprises an amplifier.

5. The apparatus according to claim 1, wherein the output signal receiving part comprises an analog-to-digital converter and a signal analyzer.

6. The apparatus according to claim 5, wherein the output signal receiving part further comprises a filter and a demodulator.

7. The apparatus according to claim 6, wherein the output signal receiving part further comprises an amplifier.

8. A surface acoustic wave (SAW) sensor system comprising:
an input signal transmitting part for transmitting an input signal to a SAW sensor, the input signal comprising a sinc function;
the SAW sensor; and
an output signal receiving part for receiving an output signal from the SAW sensor.

9. The SAW sensor system according to claim 8, wherein the input signal transmitting part comprises a sinc function generator, a digital-to-analog converter, a modulator, an amplifier, and a filter.

10. The SAW sensor system according to claim 8, wherein the output signal receiving part comprises a filter, an amplifier, a demodulator, an analog-to-digital converter, and a signal analyzer.

11. The SAW sensor system according to claim 8, wherein the SAW sensor comprises:
a piezoelectric substrate,
an inputting part for converting a first electrical signal into a first SAW,
a sensing part for sensing a target by generating a second SAW corresponding to the first SAW; and
an outputting part for converting the second SAW into a second electrical signal.

12. The SAW sensor system according to claim 11, wherein at least one of the inputting part and the outputting part is an inter-digital transducer.

13. The SAW sensor system according to claim 11, wherein the SAW is selected from the group consisting of a flexural plate wave, a Love wave, a surface skimming bulk wave, and a Lamb wave.

14. The SAW sensor system according to claim 11, wherein the target is at least one selected from the group consisting of a protein, DNA, a virus, a bacterium, a cell, a tissue, a gas, temperature, pressure, and humidity.

15. The SAW sensor system according to claim 8, wherein the SAW sensor is selected from the group consisting of a biosensor, a gas sensor, a temperature sensor, a pressure sensor, and a humidity sensor.

16. The SAW sensor system according to claim 8, wherein the output signal receiving part detects a change in at least one of frequency, phase, and intensity of the output signal from the SAW sensor.

17. A method of sensing a target, the method comprising:
generating a first sinc signal;
converting the first sinc signal into a first electrical signal with a predetermined frequency bandwidth;
inputting the first electrical signal into a surface acoustic wave (SAW) sensor;
sensing the target using a first SAW;
outputting a second SAW corresponding to the sensed target;
converting the second SAW into a second electrical signal;
converting the second electrical signal into a second sinc signal; and
comparing the first sinc signal with the second sinc signal.

18. The method according to claim 17, wherein the SAW is selected from the group consisting of a flexural plate wave, a Love wave, a surface skimming bulk wave, and a Lamb wave.

19. The method according to claim 17, wherein the target is at least one selected from the group consisting of a protein, DNA, a virus, a bacterium, a cell, a tissue, a gas, temperature, pressure, and humidity.

20. The method according to claim 17, wherein comparing the first sinc signal with the second sinc signal comprises comparing a change in at least one of frequency, phase, and energy amplitude of the first sinc signal and the second sinc signal.
